(19) United States
(12) Patent Application Publication
(10) Pub. No.: US 2024/0333006 A1
(43) Pub. Date: Oct. 3, 2024

(54) DISCRETE CONTROL PORTABLE POWER STATION DC-DC BATTERY CHARGER

(71) Applicant: MILWAUKEE ELECTRIC TOOL CORPORATION, Brookfield, WI (US)

(72) Inventor: Nathan J. Gustafson, Milwaukee, WI (US)

(21) Appl. No.: 18/618,025

(22) Filed: Mar. 27, 2024

Related U.S. Application Data
(60) Provisional application No. 63/492,885, filed on Mar. 29, 2023.

(51) Int. Cl. H02J 7/00; H01M 10/42; H01M 10/44

(52) U.S. Cl. CPC H02J 7/0048; H01M 10/441; H02J 7/0042; H01M 2010/4271

(57) ABSTRACT

A portable power supply includes a housing, a battery core located within the housing, and a battery pack charger electrically connected to the battery core and configured to charge a battery pack. The battery pack charger is galvanically isolated from the battery core.

### RELATED APPLICATIONS

This application claims the benefit of U.S. Provisional Patent Application No. 63/492,885, filed Mar. 29, 2023, the entire content of each of which is hereby incorporated by reference.

### SUMMARY

A portable power supply may be configured to draw power from a battery core to charge one or more battery packs. The portable power supply may include a low-voltage signal line galvanically isolated from a high-voltage signal line. The low-voltage signal line may carry numerous types of low-voltage signals such a state-of-charge signal, a pack present signal, a latch-off signal, a voltage fault signal, a current fault signal, a temperature fault signal, a charging fault signal, or a charge current signal. The high-voltage signal line may carry numerous types of high-voltage signals, such as housekeeping undervoltage signal, a high-voltage electronics temperature fault signal, or an input undervoltage signal.

Embodiments described herein provide a portable power supply including a housing, a battery core located within the housing, and a battery pack charger electrically connected to the battery core and configured to charge a battery pack. The battery pack charger is galvanically isolated from the battery core.

Embodiments described herein provide a portable power supply including a housing, a battery core located within the housing, and a battery pack charger located in the housing, the battery pack charger electrically connected to the battery core and configured to charge a battery pack. Galvanic isolation is provided between the battery pack and the battery core.

Embodiments described herein provide a portable power supply including a housing, a battery core located within the housing, a battery pack charger electrically connected to the battery core and configured to charge a battery pack. The battery pack charger includes a sensor configured to detect a status of the battery pack and produce an analog signal indicating the status of the battery pack. A battery management system is located within the housing and is configured to receive status signals from the battery pack charger via a galvanic isolator. The battery management system is configured to communicate the analog signal from the sensor to the battery management system. The sensor is configured to vary a voltage of the analog signal based on the status of the battery pack.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components. As another example, “control units” and “controllers” described in the specification can include one or more electronic processors, one or more memories including a non-transitory computer-readable medium, one or more input/output interfaces, and various connections (for example, a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

It should be noted that one of ordinary skill in the art, and based on a reading of this detailed description, would recognize that, in at least one instance, the electronic based aspects of the invention may be implemented in software (for example, stored on non-transitory computer-readable medium) executable by one or more processors.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

As used within this document, the word “or” may mean inclusive or. As a non-limiting example, if it were stated in this document that “item Z may comprise element A or B,” this may be interpreted to disclose an item Z comprising only element A, an item Z comprising only element B, as well as an item Z comprising elements A and B.

Other aspects of the embodiments will become apparent by consideration of the detailed description and accompanying drawings.

### BRIEF DESCRIPTION OF THE DRAWINGS

FIG. 1A illustrates a perspective view of a portable power supply device, according to embodiments described herein.

FIG. 1B illustrates a portable power supply configured to receive a plurality of charging modules in a plurality of charge ports, according to embodiments described herein.

FIG. 1C illustrates the portable power supply of FIG. 1B including a plurality of charging modules connected to the charge ports, according to embodiments described herein.

FIG. 2A is a block diagram of a portable power supply including a battery core charger, a battery core, a battery management system, and a battery pack charger, according to embodiments described herein.

FIG. 2B illustrates a detailed schematic of the battery core of the portable power supply connected to the battery management system of FIG. 2A, according to embodiments described herein.

FIG. 2C illustrates the battery pack charger of the portable power supply of FIG. 2A including a galvanic isolation barrier configured to galvanically isolate a communications circuit from a high-voltage side of the power supply, according to embodiments described herein.

FIG. 3 illustrates a hardware schematic for a portable power supply including a battery core, a battery management system (BMS), a battery pack charger subsystem including a galvanic isolator, and a battery pack detection circuit, according to embodiments described herein.

FIG. 4 illustrates a plurality of low-voltage side signals on one side of a galvanic isolation barrier, and a plurality of high-voltage side signals on the other side of the galvanic isolation barrier, according to embodiments described herein.

FIG. 5 illustrates a configuration of a galvanic isolation barrier including an optical isolator, according to some embodiments.

FIG. 6 illustrates a configuration of a galvanic isolation barrier including a capacitive isolator, according to some embodiments.

FIG. 7 illustrates a configuration of a galvanic isolation barrier including a magnetic isolator, according to some embodiments.

FIG. 8 illustrates a flow chart for communicating an analog signal from a low-voltage side to a high-voltage side of a portable power supply, according to embodiments described herein.

### DETAILED DESCRIPTION

Embodiments described herein relate to a portable power supply that includes a galvanically isolated bus configured to communicate data between system modules. The portable power supply also includes a galvanic isolation barrier configured to galvanically isolate a high-voltage side (e.g., operating at voltages greater than 60V) of the portable power supply from a low-voltage side (e.g., operating at voltages less than 60V) of the power supply. A controller on the low-voltage side of the galvanic isolator is used to produce an analog signal indicating a status of the portable power supply or a battery pack connected thereto, and to communicate the analog signal across the galvanic isolation barrier (e.g., a galvanic isolator) from the low-voltage side to the high-voltage side.

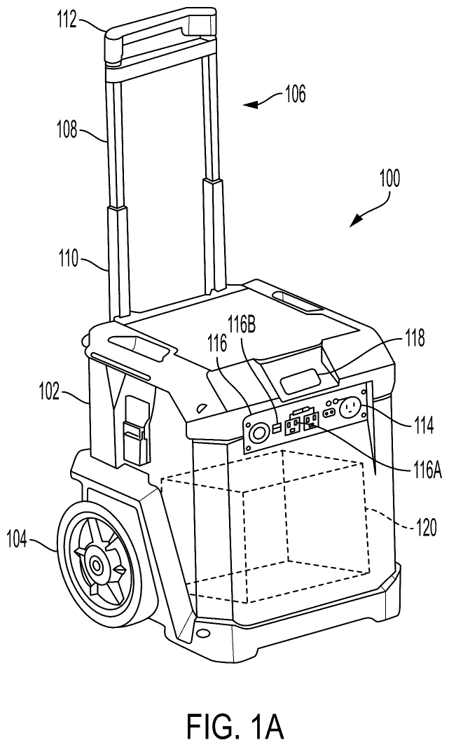

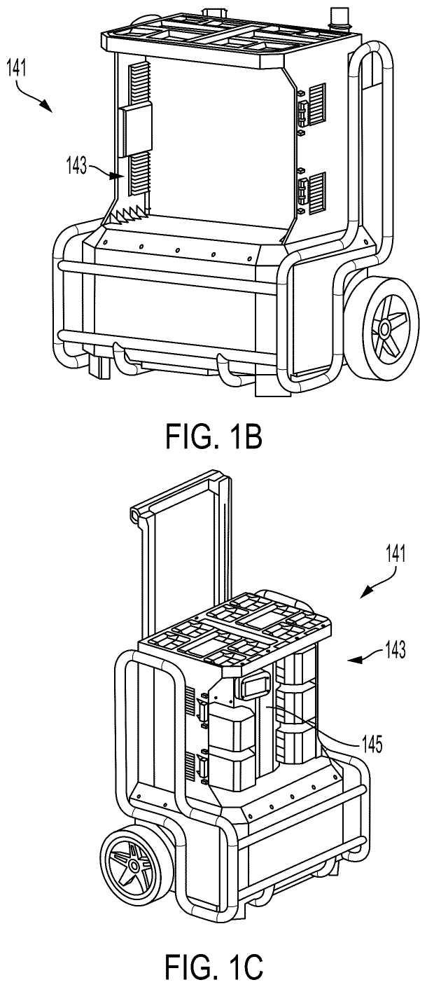

FIG. 1A illustrates a portable power supply device or power supply 100. The power supply 100 includes, among other things, a housing 102. In some embodiments, the housing 102 includes one or more wheels 104 and a handle assembly 106. In the illustrated embodiment, the handle assembly 106 is a telescoping handle movable between an extended position and a collapsed position. The handle assembly 106 includes an inner tube 108 and an outer tube 110. The inner tube 108 fits inside the outer tube 110 and is slidable relative to the outer tube 110. The inner tube 108 is coupled to a horizontal holding member 112. In some embodiments, the handle assembly 106 further includes a locking mechanism to prevent inner tube 108 from moving relative to the outer tube 110 by accident. The locking mechanism may include notches, sliding catch pins, or another suitable locking mechanism to inhibit the inner tube 108 from sliding relative to the outer tube 110 when the handle assembly 106 is in the extended position and/or in the collapsed position. In practice, a user holds the holding member 112 and pulls upward to extend the handle assembly 106. The inner tube 108 slides relative to the outer tube 110 until the handle assembly 106 locks in the extended position. The user may then pull and direct the power supply 100 by the handle assembly 106 to a desired location. The wheels 104 of the power supply 100 facilitate such movement.

The housing 102 of power supply 100 further includes a power input unit 114, a power output unit 116, and a display 118. In the illustrated embodiment, the power input unit 114 includes multiple electrical connection interfaces configured to receive power from an external power source. In some embodiments, the external power source is a DC power source. For example, the DC power source may be one or more photovoltaic cells (e.g., a solar panel), an electric vehicle (“EV”) charging station, or any other DC power source. In some embodiments, the external power source is an AC power source. For example, the AC power source may be a conventional wall outlet, such as a 120 V outlet or a 240 V outlet, found in North America. As another example, the AC power source may be a conventional wall outlet, such as a 220V outlet or 230V outlet, found outside of North America. In some embodiments, the power input unit 114 is replaced by or additionally includes a cable configured to plug into a conventional wall outlet. In some embodiments, the power input unit 114 further includes one or more devices, such as antennas or induction coils, configured to wirelessly receive power from an external power source. The power received by the power input unit 114 may be used to charge a core battery or battery core 120, disposed within the housing 102 of power supply 100.

The power received by the power input unit 114 may also be used to provide power to one or more devices connected to the power output unit 116. The power output unit 116 includes one more power outlets. In the illustrated embodiment, the power output unit 116 includes a plurality of AC power outlets 116A and DC power outlets 116B. It should be understood that the number of power outlets included in the power output unit 116 is not limited to the power outlets illustrated in FIG. 1A. For example, in some embodiments of the power supply 100, the power output unit 116 may include more or fewer power outlets than the power outlets included in the illustrated embodiment of power supply 100.

In some embodiments, the power output unit 116 is configured to provide power output by the battery core 120 to one or more peripheral devices. In some embodiments, the power output unit 116 is configured to provide power provided by an external power source directly to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output unit 116.

In some embodiments, the DC power outlets 116B also include one or more receptacles for receiving and charging power tool battery packs. In such embodiments, power tool battery packs received by, or connected to, the DC power outlets 116B are charged with power output by the battery core 120 and/or power received directly from the external power source. In some embodiments, power tool battery packs connected to the DC power outlets 116B are used to provide power to the battery core 120 and/or one or more peripheral devices connected to outlets of the power output unit 116. The DC power outlets 116B may include guide rails to receive slide-on style battery packs and latching mechanisms to secure the battery packs to DC power outlets 116B. In such embodiments, the power supply 100 includes a plurality of charging modules or charging blocks for charging various battery packs. The charging modules can have different power ratings and can be interchangeable within different charging slots within the power supply 100. As a result, the power supply 100 can be configured with various combinations of battery pack chargers for charging battery packs of different voltages, at different charging rates, etc.

In some embodiments, the power output unit 116 includes tool-specific power outlets. For example, the power output unit may include a DC power outlet used for powering a welding tool. In some embodiments, the DC power outlets 116B are configured to support charging of battery packs with various nominal voltage ratings (e.g., 12V, 18V, 36V, 72V, etc.).

A display 118 is configured to indicate a state of the power supply 100 to a user, such as state of charge of the battery core 120 and/or fault conditions. In some embodiments the display 118 includes one or more light-emitting diode (“LED”) indicators configured to illuminate and display a current state of charge of battery core 120. In some embodiments, the display 118 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, an electronic ink display, an electrochromic display, a flip dot/flip disc display, etc. In some embodiments, the display 118 is a touch screen configured to be used as a human-machine interface. The display 118 may be configured to display a graphical user interface. The power supply 100 may include user input components such as keys, trackpads, dials, knobs, touchscreens, etc., for accepting user input and updating the display 118. In other embodiments, the power supply 100 does not include a display.

FIGS. 1B and 1C illustrate another embodiment of a power supply 141 that is similar to the power supply 100 and which may include similar features. The power supply 141 may further include a compartment 143 that is configured to receive one or more charging modules 145. For example, the power supply 100, 141 may be configured with any combination of charging modules (e.g., 12V charging modules, 18V charging modules, etc.). The power supply 141 distributes, for example, a 24 V bus to the charging modules. In some embodiments, one or more of the charging modules accommodate one or more stem type battery packs or slide-on battery packs, or a combination of one or more stem battery packs and one or more slide-on battery packs, having a nominal rated voltage between, for example, 3V and 120V (e.g., 12V, 18V, 72V, 84V, etc.). The charging modules may be configured to provide a charging current to a battery pack when the battery pack is received by at least one of the charging modules. One or more of the charging modules may be electrically coupled to one or more charging ports. The charging ports may include at least one USB-C charging port that provides between 3.3 V and 21 V to a device coupled to the USB-C charging port, and/or at least one USB-A charging port that provides 5 V at 2.4 Amps to a device coupled to the USB-A charging port. In some embodiments, devices may be electrically coupled to the charging ports via charging cables. One or more of the charging modules may include a fan for cooling a battery pack. The fan may be controlled by a controller of the power supply 100 and may automatically turn on when the battery pack is inserted into one or more of the charging modules, when a sensor coupled to the controller senses that the temperature of the battery pack has reached a certain threshold value, or when data indicating that the temperature of the battery pack has reached a certain threshold value is communicated to the controller (e.g., over a digital or analog communications interface).

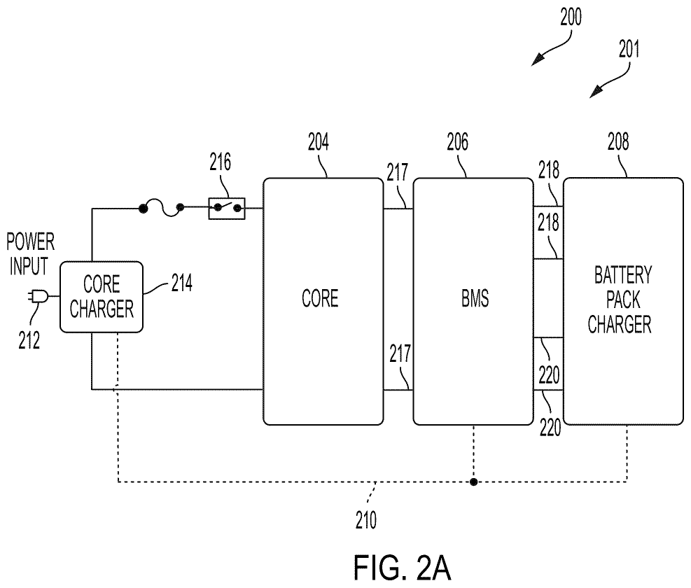

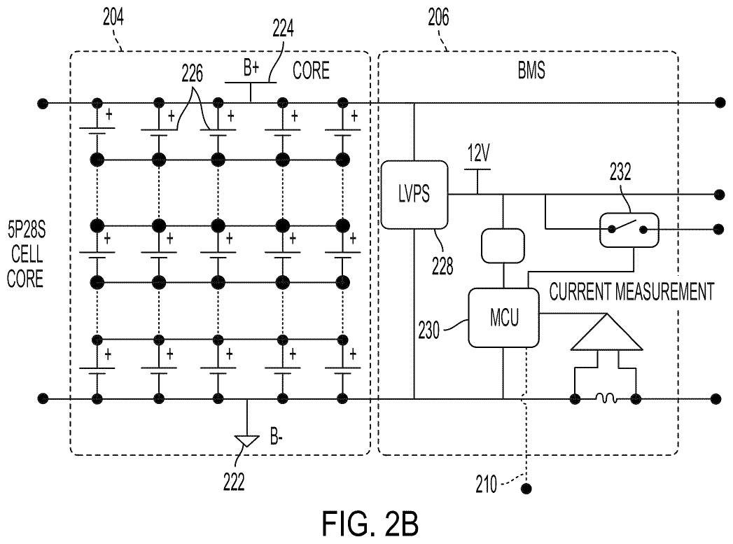

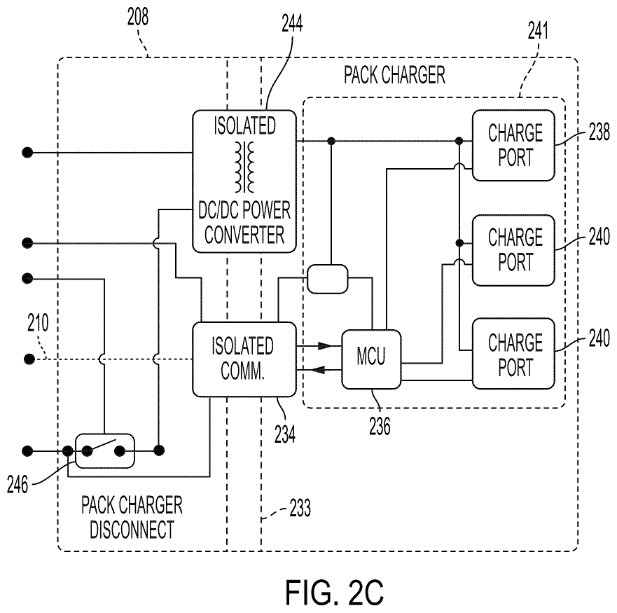

FIG. 2A illustrates a block diagram 200 of a portable power supply 201 (e.g., power supply 100, 141) including a battery core 204, a battery management system (“BMS”) 206, and a battery pack charger 208. The BMS 206 and the battery pack charger 208 are connected to the core charger 214 via a communications bus 210. A power input 212 (e.g., a plug configured to draw electrical current through a wall socket) is connected to a core charger 214 configured to provide a charging current to the battery core 204. The core charger 214 may communicate, via the bus 210, with the BMS 206 and the battery pack charger 208 for the purpose of monitoring the health of the battery core and managing the battery core and battery pack charging processes. A power supply disconnect switch 216 may be configured to disconnect the battery core 204, the BMS 206, and the pack charger 208 from current supplied by the core charger 214 via the power input 212. Power leads 217 are configured to provide current from the battery core 204 or the core charger 214 to the BMS 206 and the battery pack charger 208. Power leads 218 and 220 are configured to provide current from the BMS 206 to the battery pack charger 208. For example, the power leads 218 may be configured to supply current supplied by the battery core 204, or in some cases the core charger 214, directly to the battery pack charger 208, while power leads 220 are configured to provide, for example, a 12V signal, produced by a low-voltage power supply (“LVPS”) 228 (see FIG. 2B), to the battery pack charger 208.

FIG. 2B illustrates a detailed schematic of the battery core 204 of the portable power supply 100 connected to the BMS 206. The battery core 204 includes a positive terminal 224 and a negative terminal 222. The battery core 204 further includes a plurality of core cells 226 connected in series and parallel and configured to be charged by the core charger 214. Although illustrated as being connected in series and parallel, the core cells 226 may be electrically connected in series, in parallel, and/or a combination thereof. In some embodiments, the core cells 226 are implemented as rechargeable 24V groups or packs. In some embodiments, the rechargeable groups or packs may be relatively high-voltage (e.g., 72V, 100V, 120V, 240V, etc.). Additionally, the battery core 204 may include as many core cells 226 as desired. For example, the battery core 204 may include two, three, four, ten, twenty, twenty-three, twenty-eight, forty-six, seventy or more battery cells electrically connected in series.

The core cells 226 included in the battery core 204 may be rechargeable battery cells having a lithium ion chemistry, such as lithium phosphate or lithium manganese. In some embodiments, the core cells 226 may have lead acid, nickel cadmium, nickel metal hydride, and/or other chemistries. In some embodiments, the core cells 226 are pouch battery cells (e.g., lithium-based pouch battery cells). Each core cell 226 in the battery core 204 has an individual nominal voltage. The nominal voltage of an individual core cell 226 included in the battery core 204 may be, for example, 4.2V, 4V, 3.9V, 3.6V, 2.4V, or some other voltage value. Naturally, the nominal voltages of the individual core cells 226 included in each group or pack may be stacked. For example, if a group or pack of core cells 226 includes two core cells 226 having nominal voltages of 4V, and the two core cells 226 are connected in series, voltage of the group or pack of core cells 226 is equal to 8.0V. Additionally, the amp-hour capacity, or capacity, of battery core 204 may be increased by adding core cells 226 connected in a parallel-series combination to the battery core 204. In some embodiments, the battery core 204 includes a removable battery pack configured to be inserted and removed from the housing 102. In such embodiments, the removable battery pack may be connected in series or parallel to other battery packs as described above to provide a desired voltage or amp-hour capacity. Further, in such embodiments, the battery core may include non-removable cells and removable cells (e.g., in the form of individual removable cells or in the form of removable battery packs including a plurality of cells) connected to one another.

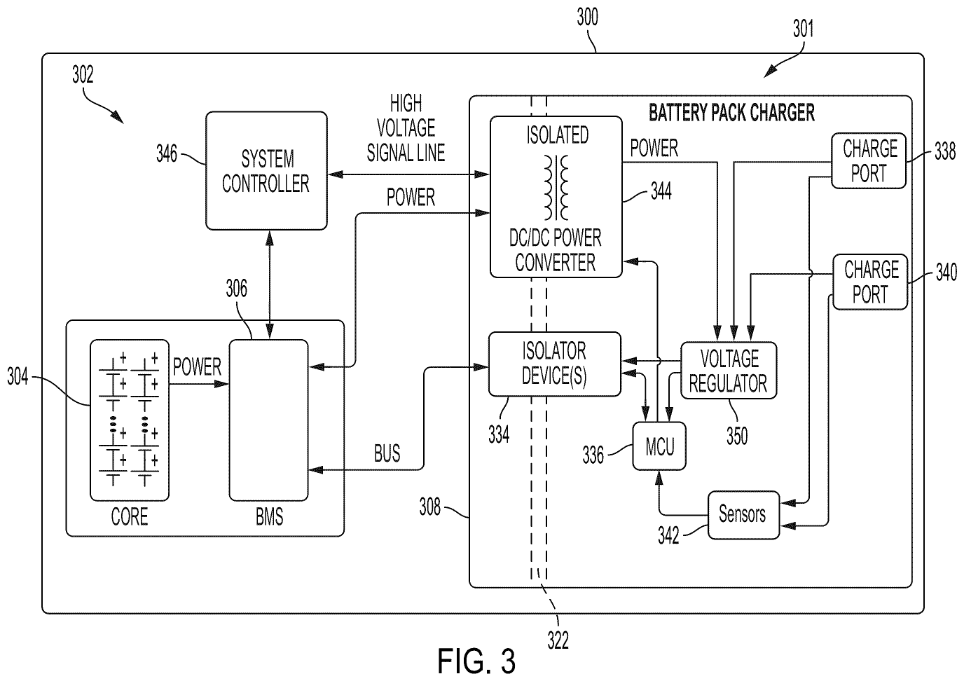

The BMS 206 is configured to provide current and voltage, as needed, from the battery core charger 214, the battery core 204, or the LVPS 228 to the battery pack charger 208. For example, the LVPS 228 may be configured to provide a 12V power output to a galvanic isolation circuit (referred to herein generally as a “galvanic isolation barrier”) such as a galvanically isolated transceiver (see FIG. 3) or a galvanic isolation circuit for a continuation of the communications bus itself (see FIG. 3). The BMS 206 may also include a controller or microcontroller (“MCU”) 230 and transceiver 230 configured to communicate with the battery core charger 214 and the battery pack charger 208 to manage the provision of current from the battery core charger 214 to the battery core 204, and from the battery core 204 and the battery core charger 214 to the battery pack charger 208. The MCU and transceiver 230 are also configured to measure current drawn by the battery pack charger 208 and to manipulate a BMS disconnect switch 232 based on the current measurement. For example, if the current drawn by the battery pack charger 208 spikes to an unsafe level, the MCU and transceiver 230 may open the BMS disconnect switch 232, which may cause a battery pack charger disconnect switch 246 (shown in FIG. 2C) to open, thereby preventing the flow of charging current to a charging port (see FIG. 2C). Current drawn by the battery pack charger 208 may also be measured with respect to the battery core 204, and used by the BMS 206 for determining the state of charge of the battery core 204. Additionally, in some embodiments, in order to prevent the battery pack charger 208 from draining the battery core 204 when the battery pack charger 208 is not in active operation, the BMS 206 opens the BMS disconnect switch 232, which causes the battery pack charger disconnect switch 246 to disconnect the battery core 204.

FIG. 2C illustrates an example of the battery pack charger 208 of the portable power supply 100 including a galvanic isolation barrier 233 configured to galvanically isolate a communications circuit 234 (e.g., a transceiver) from the bus 210 and from other voltages in the battery core 204 and in the BMS 206. The communications circuit 234 is configured to communicate with a battery pack charger microcontroller 236 connected to a plurality of battery pack charging ports 238, 240. The charging ports 238, 240 are configured to charge devices connected to one or more charging modules 241 with an appropriate charging current at a specified voltage (e.g., 12V, 18V, etc.). In some embodiments, the charging modules 241 may be added to or removed from the battery pack charger 208 as desired. The battery pack charger microcontroller 236 (sometimes referred to herein as the charge controller) is configured to control the charging ports 238, 240 (e.g., start charge, stop charge, pause charge, restart charge, etc.). The battery pack charger microcontroller 236 is configured to accept and execute commands received from the BMS 206 via the communications circuit 234. In this way the BMS 206 may manage the operation of charging ports 238, 240, via the battery pack charger microcontroller 236. A DC/DC power converter 244 is configured to condition current received from the BMS 206 to ensure an appropriate voltage charging signal is provided to the charging ports 238, 240. The battery pack charger microcontroller (“MCU”) 236 may be configured to selectively interrupt the flow of current to charging ports 238, 240 in response to the conditioned current signal to protect one or more devices connected to the charging ports 238, 240. A battery pack charger disconnect switch 246 is configured to open based on a state (e.g., open, closed) of the BMS disconnect switch 232, as described above, thereby preventing the flow of charging current to the charging ports 238, 240.

FIG. 3 illustrates another hardware schematic 300 for a power supply including a battery core 304 (e.g., power supply 100), a BMS 306, a galvanically isolated battery pack charger 308, and a system controller 346. The galvanically isolated battery pack charger 308 includes a galvanic isolation barrier 332 defined by the operations of an isolator device 334 and an isolated DC/DC power converter 344. In some embodiments, the isolator device 334 includes a plurality of isolator devices, and the isolator devices can be analog, digital, or a combination of analog and digital isolator devices. For example, one discrete isolator device corresponds to each piece of information that is to be transmitted across the galvanic isolation barrier. In some embodiments, multiple discrete isolator devices can each be used to communicate a single piece of status information across the galvanic isolation barrier (e.g., a piece of status information pertaining to a status of a connected battery or a status of the power supply). For example, a plurality of optical isolators may be used to collectively communicate a status of a connected battery pack. The battery pack charger 308 further includes a battery pack charger controller 336, a voltage regulator 350, and charging ports 338, 340, and sensors 342. When a battery pack is connected to one of the charging ports 338, 340, an initial current pulse from the battery pack may drive the voltage regulator 350, which is configured to drive the battery pack charger controller 336 in turn. The battery pack charger controller 336 is configured to receive data from sensors 342 and to produce (e.g., generate) and communicate signals to and from the BMS 306 across the galvanic isolation barrier 332 via the isolator device 334 or to and from the system controller 346 via the isolated DC/DC power converter 344. Specifically, the isolator device 334 is configured to facilitate galvanically isolated communication of signals between the low-voltage side 301 (e.g., the battery pack charger 308) of the power supply 100 and the high-voltage side 302 (e.g., the BMS 306) of the power supply 100, and the isolated DC/DC power converter 344 is configured to facilitate galvanically isolated communication of signals between the low-voltage side 301 (e.g., the battery pack charger 308) of the power supply 100 and the high-voltage side 302 (e.g., the BMS 306) of the power supply 100.

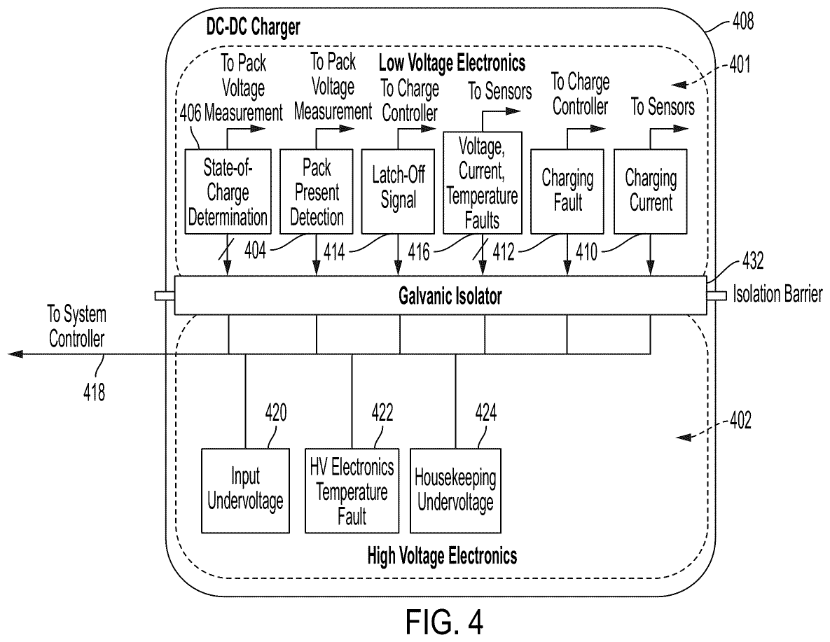

Sensors 342 are connected to charging ports 338, 340 and may be configured to determine that a battery pack is connected to at least one of the charging ports 338, 340 (e.g., battery pack present detection 404, as shown in FIG. 4), to measure an electrical characteristic of the battery pack such as a state of charge (SOC) of a connected battery pack (e.g., state-of-charge determinations 406), to monitor a charging current being conducted to a connected battery pack, or to sense a charging fault (e.g., overtemperature, under-temperature, overvoltage, undervoltage, overcurrent, undercurrent, etc.). Although specific connections are not shown, the sensors 342 may also be configured to determine the voltage, current, and temperatures of the various circuits in the battery pack charger 308 (e.g., the voltage regulator 350, the battery pack charger controller 336, the isolator device 334, the isolated DC/DC power converter 344, and the charging ports 338, 340). Additionally, the sensors 342 may be configured to monitor the positions of switches of the power supply 100 (e.g., power supply disconnect switch 216, BMS disconnect switch 232, and battery pack charger disconnect switch 246) and other hardware states. Anything sensed by the sensors 342 may be communicated to the battery pack charger controller 336 and subsequently communicated to the BMS 306 via the galvanic isolation barrier 332 as a digital signal via the isolator device 334, or as an analog signal via the isolated DC/DC power converter 344 and the system controller 346.

FIG. 4 illustrates a plurality of low-voltage side signals on a low-voltage side 401 of a galvanic isolation barrier, and a plurality of high-voltage side signals on the high-voltage side 402 of the galvanic isolation barrier. Analog signals representing faults, measurements, determinations, etc., related to a battery pack charger 408 (or 208, 308) or connected battery packs as appropriate, are produced via the battery pack charger controller 336 on the low-voltage side 401 (e.g., at the battery pack charger 408) of a galvanic isolation barrier 432 and communicated across the galvanic isolation barrier 432 and to the system controller 346 via a high-voltage signal line 418 on the high-voltage side 402. On the low-voltage side 401 of the galvanic isolation barrier 432, the battery pack charger controller 336 may be configured to produce faults based on data received from the sensors 342. For example, a latch-off fault 414 may be produced by the battery pack charger controller 336 when a latch switch (not shown) is designed to turn off a component, such as a power transistor, in response to an overcurrent (e.g., based on charging current 410) or overvoltage event, and then keeps that component turned off even after the fault has been corrected. The sensors 342 may be configured to determine that the disabled component is unnecessarily disabled, and the battery pack charger controller 336 may produce a latch-off fault accordingly. The battery pack charger controller 336 may also produce faults 416 based on a measured voltage, current, or temperature of a connected battery pack or any of the circuits of the battery pack charger 408, charging faults 412, etc.

Analog signals representing faults, measurements, determinations, etc., (e.g., input undervoltage fault 420, high-voltage electronics temperature fault 424, and housekeeping undervoltage fault 422) related to the BMS 306 and the system controller 346 are produced via the MCU and transceiver 230 on the high-voltage side 402 (e.g., at the BMS 306) of the galvanic isolation barrier 432 and communicated to the system controller 346 via the high-voltage signal line 418 on the high-voltage side 402 of the galvanic isolation barrier 432. On the high-voltage side 402 of the galvanic isolation barrier 432, the MCU and transceiver 230 may produce an input undervoltage fault 420, a housekeeping undervoltage fault 422, and a high-voltage electronics temperature fault 424 in response to data indicative of a fault from sensors 342. This list of signals (e.g., faults, measurements, determinations, etc.) is not exhaustive, but is representative of signals for a robust control system.

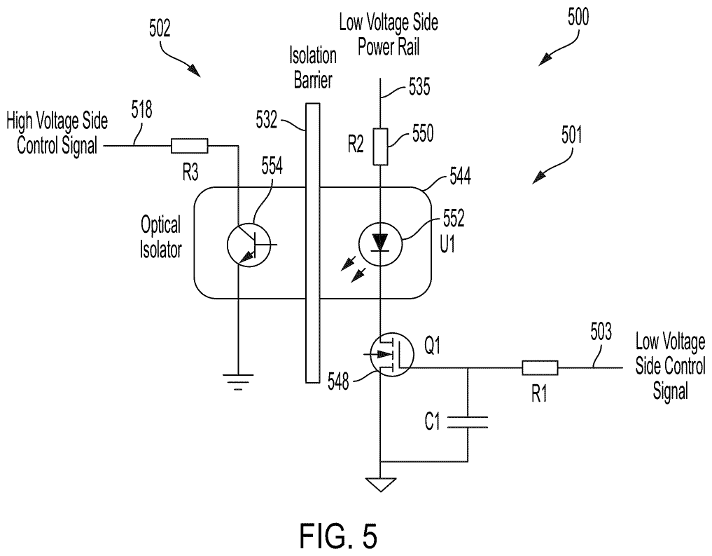

FIG. 5 illustrates an embodiment of the isolator device 334 including a discrete optical isolator 500 in the form of an optocoupler 544. The isolator device 334 includes the optocoupler 544 configured to draw the high-voltage signal line 518 high when excited by a signal on the low-voltage signal line 503 on the low-voltage side 501 of the galvanic isolation barrier 532. In the embodiment shown, an analog signal on the low-voltage power rail 535 is provided to transistor 548, and transfers over to the high-voltage side 502 of the galvanic isolation barrier 532 accordingly. For example, if a fault has occurred, the low-voltage signal may turn transistor 548 on, causing current to flow on the low-voltage side 501 through resistor 550 and illuminate light source 552. This turns on transistor 554 in the optical isolator 500, pulling the voltage on the high-voltage signal to ground, causing an analog high-voltage signal to be conducted through the high-voltage signal line 518.

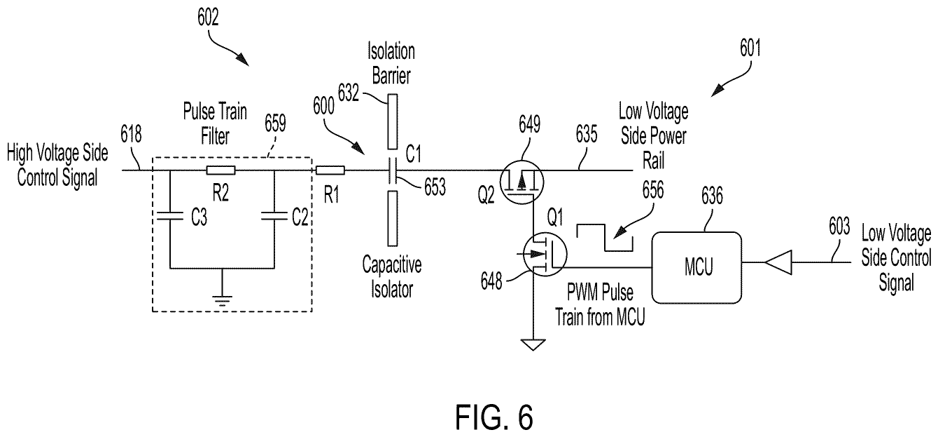

FIG. 6 illustrates an embodiment of the isolator device 334 including a discrete capacitive isolator 600 in the form of a capacitor 653. The isolator device 334 includes the capacitor 653 configured to draw the high-voltage signal line 618 high when excited by a signal on the low-voltage signal line 503 on the low-voltage side 601 of the isolation barrier 632. In the embodiment shown, a signal (fault status, battery pack status, etc.) on the low-voltage signal line 603 is provided to the battery pack charger controller 636. The battery pack charger controller 636 produces a pulse width modulated (PWM) pulse train 656 indicative of the analog signal received. The pulse train 656 is communicated to transistor 648, causing the transistor 648 to conduct current in response to positive voltages in the pulse train 656. In turn, transistor 649 conducts current on the on the low-voltage power rail 635 while transistor 648 conducts. The current conducted on the low-voltage power rail 635 charges capacitor 653 intermittently as transistor 649 alternates between on and off configurations and intermittently conducts current on the low-voltage power rail 635 accordingly. In response to this intermittently conducted current, the capacitor 653 intermittently raises the voltage of the high-voltage signal line 618. On the high-voltage side 602, the intermittent voltage signal on the high-voltage signal line 618 is filtered, via pulse train filter 659, to a steady DC value (e.g., an analog signal) and the signal is communicated to the system controller 346.

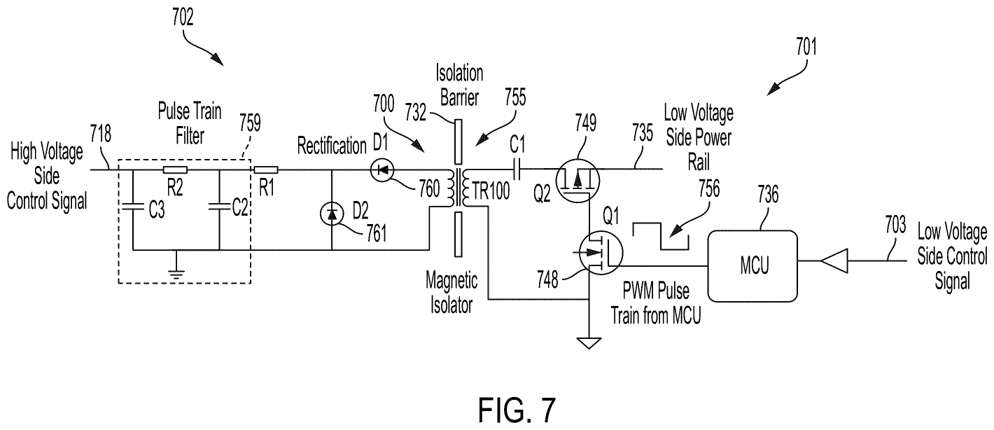

FIG. 7 illustrates an embodiment of the isolator device 334 including a discrete magnetic isolator 700 in the form of a transformer 755. The isolator device 334 includes the transformer 755 configured to draw the high-voltage signal line 718 high when excited by a signal on the low-voltage signal line 703 on the low-voltage side 701 of the galvanic isolator 732. In the embodiment shown, a signal (fault status, battery pack status, etc.) on the low-voltage signal line 703 is provided to the battery pack charger controller 736. The battery pack charger controller 736 produces a pulse width modulated (PWM) pulse train 756 indicative of the analog signal received. The pulse train 756 is communicated to transistor 748, causing the transistor 748 to conduct current in response to positive voltages in the pulse train 756. In turn, transistor 749 conducts current on the on the low-voltage power rail 735 while transistor 748 conducts. The current conducted on the low-voltage power rail 735 excites transformer 755 intermittently as transistor 749 alternates between on and off configurations and intermittently conducts current on the low-voltage power rail 735 accordingly. In response to this intermittently conducted current, the transformer 755 intermittently raises the voltage of the high-voltage signal line 718. On the high-voltage side 702, the intermittent voltage signal on the high-voltage signal line 718 is rectified by rectifying diodes 760, 761, and filtered, via pulse train filter 759, to a steady DC value (e.g., an analog signal) and communicated to the system controller.

In response to receiving a signal on the high-voltage signal line, the system controller 346 may interpret the analog signal and cause the display 118 to display the information contained in the interpreted signal. For example, using the capacitive isolator or magnetic isolator configurations of the isolated DC/DC power converter 344, a variable voltage signal could be provided, with different voltage levels representing different states of charge of a connected battery pack. Upon receiving such a signal, the system controller 346 may cause the display 118 to graphically display, for example, a status of the connected battery pack based on the signal.

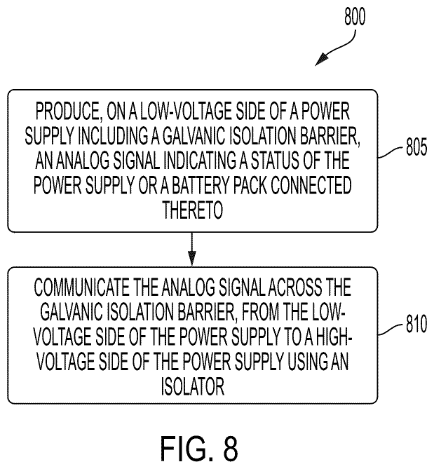

FIG. 8 is a flow chart illustrating the process 800 for communicating, in a power supply 100 including one or more galvanic isolation barriers, an analog signal from a low-voltage side 301 of the galvanic isolation barrier to a high-voltage side 302 of the galvanic isolation barrier.

At block 805, the power supply 100 produces, on the low-voltage side 301 of the galvanic isolation barrier (e.g., isolated DC/DC power converter 344), an analog signal having a voltage indicating a status of the power supply 100 or a battery pack connected thereto (e.g., power supply fan disabled, power supply overheated, battery pack presence or absence, battery pack charging status, etc.).

At block 810, the power supply 100 communicates the analog signal across the galvanic isolation barrier (e.g., isolated DC/DC power converter 344), from the low-voltage side 301 of the power supply 100 to the high-voltage side 302 using one or more of the optical isolator 500, the capacitive isolator 600, or the magnetic isolator 700. In some embodiments, all three types of isolator devices can be used. For example, for slower signals, the optical isolator 500 can be used, but for higher speed signals, the capacitive isolator 600 or the magnetic isolator 700 can be used. The power supply can include any number of discrete isolators to convey a desired amount of information across the isolation barrier.

Thus embodiments described herein provide, among other things, systems and methods for communicating analog signals across an isolation barrier within a power supply.

Various, embodiments, examples, features and advantages are set forth in the following claims.

What is claimed is:

1. A portable power supply comprising:
a housing;
a battery core located within the housing; and
a battery pack charger electrically connected to the battery core and configured to charge a battery pack,
wherein the battery pack charger is galvanically isolated from the battery core.

2. The portable power supply of claim 1, further comprising:
a battery management system located within the housing and configured to receive status signals from the battery pack charger.

3. The portable power supply of claim 2, further comprising:
a galvanic isolator connected between the battery management system and the battery pack charger, the galvanic isolator configured to provide the galvanic isolation.

4. The portable power supply of claim 3, wherein the galvanic isolator is one selected from the group consisting of an optical isolator, a magnetic isolator, and a capacitive isolator.

5. The portable power supply of claim 3, wherein the battery pack charger further includes
a sensor configured to detect an electrical characteristic of the battery pack and produce an analog signal indicating a status of the battery pack based on the detected electrical characteristic;
wherein the sensor is further configured to communicate the analog signal received from the sensor to the battery management system via the galvanic isolator.

6. The portable power supply of claim 5, wherein the sensor is configured to vary a voltage of the analog signal based on the status of the battery pack.

7. The portable power supply of claim 3 wherein the galvanic isolator includes a plurality of optical isolators, wherein the plurality of optical isolators are configured to collectively communicate a status of the battery pack to the battery management system via the galvanic isolator, wherein each of the plurality of optical isolators corresponds to a piece of status information to be communicated via the galvanic isolator, the piece of status information pertaining to a status of the battery pack.

8. A portable power supply comprising:
a housing;
a battery core located within the housing; and
a battery pack charger located in the housing, the battery pack charger electrically connected to the battery core and configured to charge a battery pack,
wherein galvanic isolation is provided between the battery pack and the battery core.

9. The portable power supply of claim 8, further comprising:
a battery management system located within the housing and configured to receive status signals from the battery pack charger.

10. The portable power supply of claim 9, further comprising:
a galvanic isolator connected between the battery management system and the battery pack charger, the galvanic isolator configured to provide the galvanic isolation.

11. The portable power supply of claim 10, wherein the galvanic isolator is one selected from the group consisting of an optical isolator, a magnetic isolator, and a capacitive isolator.

12. The portable power supply of claim 10 wherein the galvanic isolator includes a plurality of optical isolators, wherein the plurality of optical isolators are configured to collectively communicate a status of the battery pack to the battery management system via the galvanic isolator, wherein each of the plurality of optical isolators corresponds to a piece of status information to be communicated via the galvanic isolator, the piece of status information pertaining to a status of the battery pack.

13. The portable power supply of claim 10, wherein the battery pack charger further includes
a sensor configured to detect an electrical characteristic of a battery pack and produce an analog signal indicating a status of the battery pack based on the detected electrical characteristic;
wherein the sensor is further configured to communicate the analog signal received from the sensor to the battery management system via the galvanic isolator.

14. The portable power supply of claim 13, wherein the sensor is configured to vary a voltage of the analog signal based on the status of the battery pack.

15. A portable power supply comprising:
a housing;
a battery core located within the housing;
a battery pack charger electrically connected to the battery core and configured to charge a battery pack, the battery pack charger including a sensor configured to detect a status of the battery pack and produce an analog signal indicating the status of the battery pack;
a battery management system located within the housing and configured to
receive status signals from the battery pack charger via a galvanic isolator; and,
communicate the analog signal from the sensor to the battery management system,
wherein the sensor is configured to vary a voltage of the analog signal based on the status of the battery pack.

16. The portable power supply of claim 15, further including a plurality of galvanic isolators located in the housing, wherein each configured to communicate a status of the battery pack to the battery management system.

17. The portable power supply of claim 15, further including a galvanic isolator located in the housing, wherein the galvanic isolator is one selected from the group consisting of an optical isolator, a magnetic isolator, and a capacitive isolator.

18. The portable power supply of claim 17, wherein the status of the battery pack includes at least one selected from the group consisting of a battery pack state of charge, a battery pack presence, a latch-off signal, a voltage fault, a current fault, a temperature fault, a charging fault, and a charging current.
